(19) United States
(12) Patent Application Publication
(10) Pub. No.: US 2026/0268655 A1
(43) Pub. Date: Sep. 10, 2026

(54) METHOD AND DEVICE WITH IMAGE QUALITY ASSESSMENT

(71) Applicant: Samsung Electronics Co., Ltd., Suwon-si (KR)

(72) Inventors: Song JIANG, Xi’an (CN); Lijuan JIAO, Xi’an (CN); Sehwan KI, Suwon-si (KR); Ran YANG, Xi’an (CN); Pei YOU, Xi’an (CN); Hyong Euk LEE, Suwon-si (KR)

(73) Assignee: Samsung Electronics Co., Ltd., Suwon-si (KR)

(21) Appl. No.: 19/545,683

(22) Filed: Feb. 20, 2026

(30) Foreign Application Priority Data
Mar. 7, 2025 (CN) 202510271909.9
Sep. 12, 2025 (KR) 10-2025-0130885

(51) Int. Cl. G06V 10/98; G06V 10/774; G06V 10/82

(52) U.S. Cl. CPC G06V 10/993; G06V 10/774; G06V 10/82

(57) ABSTRACT

A processor-implemented method including extracting a target textual embedding corresponding to a target quality issue description related to at least two target images through a text encoder of an image quality assessment (IQA) model, extracting a target visual embedding for the at least two target images through a visual encoder of the IQA model, extracting a target quality embedding corresponding to at least one quality indicator for the at least two target images through a quality enhancer of the IQA model, obtaining a target concatenated embedding by concatenating the target textual embedding, the target visual embedding of the at least two target images, and the target quality embedding, and predicting a QA target answer for the at least two target images through a large language model (LLM) of the IQA model based on the target concatenated embedding.

### CROSS-REFERENCE TO RELATED APPLICATIONS

This application claims the benefit under 35 USC § 119(a) of Chinese Patent Application No. 202510271909.9 filed on Mar. 7, 2025, in the China National Intellectual Property Administration, and Korean Patent Application No. 10-2025-0130885 filed on Sep. 12, 2025, in the Korean Intellectual Property Office, the entire disclosures of which are incorporated by reference herein for all purposes.

### BACKGROUND

### 1. Field

The following description relates to a computer technology field, and more particularly, to a method and device with image quality assessment.

### 2. Description of Related Art

With the rapid development of smart devices and social media, users are demanding increasingly higher quality for images captured or transmitted through networks. Accordingly, optimizing the imaging system of a smart device or the image transmission system of a social network based on image quality assessment (IQA) results is becoming an increasingly important demand. For example, in the imaging system of a smart device, an image signal processor (ISP) module plays a key role in converting RAW data of a sensor into a red, green, blue (RGB) image. Therefore, IQA may be used to optimize the parameters of the ISP.

Typically, there are various IQA schemes such as DepictQA. DepictQA is based on the LLaVA model and includes an image encoder of a contrastive language-image pre-training (CLIP) model, a text encoder, and a large language model (LLM). DepictQA uses the image encoder of the CLIP model as an image feature extractor. However, due to the limitations of the pre-training targets of CLIP, while the image encoder performs well in obtaining the semantic features (also referred to as content features or visual features) of an image, it is relatively weak in extracting image quality features. In this case, for images with similar content (also referred to as fine-grained images), the feature similarity extracted by the image encoder may be high, which may make it difficult for the subsequent LLM to accurately distinguish differences in quality between these similar content images. In other words, typical methods and devices face difficulties in accurately comparing and assessing the quality of fine-grained images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including extracting a target textual embedding corresponding to a target quality issue description related to at least two target images through a text encoder of an image quality assessment (IQA) model, extracting a target visual embedding for the at least two target images through a visual encoder of the IQA model, extracting a target quality embedding corresponding to at least one quality indicator for the at least two target images through a quality enhancer of the IQA model, obtaining a target concatenated embedding by concatenating the target textual embedding, the target visual embedding of the at least two target images, and the target quality embedding, and predicting a QA target answer for the at least two target images through a large language model (LLM) of the IQA model based on the target concatenated embedding.

The quality enhancer may include a quality projector and the obtaining of the target concatenated embedding may include aligning the target quality embedding of the at least two target images with the target textual embedding through the quality projector to obtain an aligned target quality embedding and concatenating the target textual embedding, the target visual embedding of the at least two target images, and the aligned target quality embedding to obtain the target concatenated embedding.

The quality enhancer may include a quality feature extractor and the extracting of the target quality embedding may include extracting a quality feature value corresponding to the at least one quality indicator for each of the at least two target images through the quality feature extractor and generating the target quality embedding based on the extracted quality feature value.

The quality enhancer may include a salient regions sampler, and the method may include sampling at least one salient region from each of the at least two target images through the salient regions sampler and the extracting of the quality feature value may include extracting a quality feature value corresponding to the at least one quality indicator from the at least one salient region through the quality feature extractor.

The QA target answer may include a quality comparison result of the at least two target images and a causal inference description for the quality comparison result.

The at least one quality indicator may include any one or any combination of chromaticity, contrast, saturation, brightness, noise, Gaussian blur, and compression.

The method may include training the IQA model, the training including obtaining a training image sample including at least two training images, a training quality issue description for the at least two training images, and a corresponding training QA answer label, extracting a training textual embedding corresponding to the training quality issue description through a training text encoder, extracting a training visual embedding for each of the at least two training images through a training visual encoder, extracting a quality embedding corresponding to at least one quality indicator for each of the at least two training images through a training quality enhancer, obtaining a concatenated embedding by concatenating the training textual embedding, the training visual embedding of the at least two training images, and the training quality embedding, predicting a training QA answer for the at least two training images through the LLM based on the concatenated embedding, and training the IQA model by adjusting a parameter of the LLM based on the training QA answer label and the training QA answer.

The obtaining of the training concatenated embedding may include obtaining a training aligned quality embedding by aligning the training quality embedding of the at least two training images with the training textual embedding through a training quality projector and obtaining a training concatenated embedding by concatenating the training textual embedding, the training visual embedding of the at least two training images, and the training aligned quality embedding, and the adjusting of the parameter of the LLM may include adjusting parameters of the LLM and the quality projector.

The extracting of the training quality embedding may include extracting a training quality feature value corresponding to the at least one training quality indicator for each of the at least two training images through a training quality feature extractor and generating the training quality embedding based on the extracted training quality feature value.

The training may include sampling at least one salient region from each of the at least two training images through a training salient regions sampler and the extracting of the training quality feature value may include extracting the training quality feature value corresponding to the at least one training quality indicator from the at least one salient region through the training quality feature extractor.

The training QA answer may include a training quality comparison result of the at least two training images and a training causal inference description for the training quality comparison result.

In a general aspect, here is provided a non-transitory computer-readable storage medium storing instructions that, when executed by a processor, cause the processor to perform the method.

In a general aspect, here is provided an electronic device including at least one processor and a memory storing instructions, the instructions, in response to being executed by the at least one processor individually or collectively, causing the electronic device to extract a target textual embedding corresponding to a target quality issue description related to at least two target images through a text encoder of an image quality assessment (IQA) model, extract a target visual embedding for the at least two target images through a visual encoder of the IQA model, extract a target quality embedding corresponding to at least one quality indicator for the at least two target images through a quality enhancement processing element of the IQA model, obtain a target concatenated embedding by concatenating the target textual embedding, the target visual embedding of the at least two target images, and the target quality embedding, and predict a QA target answer for the at least two target images through a large language model (LLM) of the IQA model based on the target concatenated embedding.

The quality enhancement processing element may include a quality projector and the instructions, in response to being executed by the at least one processor individually or collectively, may cause the electronic device to align the target quality embedding of the at least two target images with the target textual embedding through the quality projector to obtain an aligned target quality embedding and concatenate the target textual embedding, the target visual embedding of the at least two target images, and the aligned target quality embedding to obtain the target concatenated embedding.

The quality enhancement processing element may include a quality feature extraction processing element and the instructions, in response to being executed by the at least one processor individually or collectively, may cause the electronic device to extract a quality feature value corresponding to the at least one quality indicator for each of the at least two target images through the quality feature processing element and generate the target quality embedding based on the extracted quality feature value.

The quality enhancement processing element may include a salient regions sampling processing element and the instructions, in response to being executed by the at least one processor individually or collectively, may cause the electronic device to sample at least one salient region from each of the at least two target images through the salient regions sampling processing element and extract the quality feature value corresponding to the at least one quality indicator from the at least one salient region through the quality feature extraction processing element.

The QA target answer may include a quality comparison result of the at least two target images and a causal inference description for the quality comparison result.

The at least one quality indicator may include any one or any combination of chromaticity, contrast, saturation, brightness, noise, Gaussian blur, and compression.

The instructions, in response to being executed by the at least one processor individually or collectively, may cause the electronic device to train the IQA model, the training of the IQA model including obtaining a training image sample including at least two training images, a training quality issue description for the at least two training images, and a corresponding training QA answer label, extracting a training textual embedding corresponding to the training quality issue description through a training text encoder, extracting a training visual embedding for each of the at least two training images through a training visual encoder, extracting a quality embedding corresponding to at least one quality indicator for each of the at least two training images through a training quality enhancer, obtaining a concatenated embedding by concatenating the training textual embedding, the training visual embedding of the at least two training images, and the training quality embedding, predicting a training QA answer for the at least two training images through the LLM based on the concatenated embedding, and training the IQA model by adjusting a parameter of the LLM based on the training QA answer label and the training QA answer.

The obtaining of the training concatenated embedding may include obtaining a training aligned quality embedding by aligning the training quality embedding of the at least two training images with the training textual embedding through a training quality projector and obtaining a training concatenated embedding by concatenating the training textual embedding, the training visual embedding of the at least two training images, and the training aligned quality embedding, and the adjusting of the parameter of the LLM may include adjusting parameters of the LLM and the quality projector.

Other features and aspects will be apparent from the following detailed description, the drawings, and the claims.

### BRIEF DESCRIPTION OF THE DRAWINGS

FIG. 1 illustrates an example of a typical DepictQA framework.

FIG. 2 illustrates an example multimodal large language model (MLLM)-based image quality assessment (IQA) framework according to one or more embodiments.

FIG. 3 illustrates an example sampled salient region according to one or more embodiments.

FIG. 4 illustrates an example method with IQA according to one or more embodiments.

FIG. 5 illustrates example eye movements.

FIG. 6 illustrates an example process with pure concatenation according to one or more embodiments.

FIG. 7 illustrates an example process with feature integration based on a quality projector and a visual projector according to one or more embodiments.

FIG. 8 illustrates an example method with IQA model training according to one or more embodiments.

FIG. 9 illustrates an example electronic apparatus with IQA according to one or more embodiments.

FIG. 10 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used in connection with various example embodiments of the disclosure, any use of the terms "module" or "unit" means hardware and/or processing hardware configured to implement software and/or firmware to configure such processing hardware to perform corresponding operations, and may interchangeably be used with other terms, for example, "logic," "logic block," "part," or "circuitry". As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Typical image quality assessment (IQA) models are based on datasets that include human mean opinion score (MOS) and optimize a target, through a regression task, of a trainable network so that the models may accurately approximate MOS values. However, these models may only make simple binary judgments about image quality and may not obtain more detailed descriptions or summaries about image quality. Furthermore, fueled by the scaling law of the transformer architecture and advances in the computational power of graphics processing units (GPUs), multimodal large language models (MLLMs) have been rapidly evolving, demonstrating outstanding performance in high-dimensional visual question answering (VQA) tasks. Accordingly, researchers are attempting to apply MLLMs to the field of IQA. A typical technical approach for these models involves the following stages: first, constructing a large-scale dataset that includes image quality descriptions, then efficiently fine-tuning a general-purpose domain-based MLLM. For example, DepictQA, an MLLM targeting IQA tasks fine-tunes the general-purpose MLLM LLaVA primarily by leveraging the large-scale dataset DQ-495K and an efficient fine-tuning technique based on low-rank adaptation (LoRA).

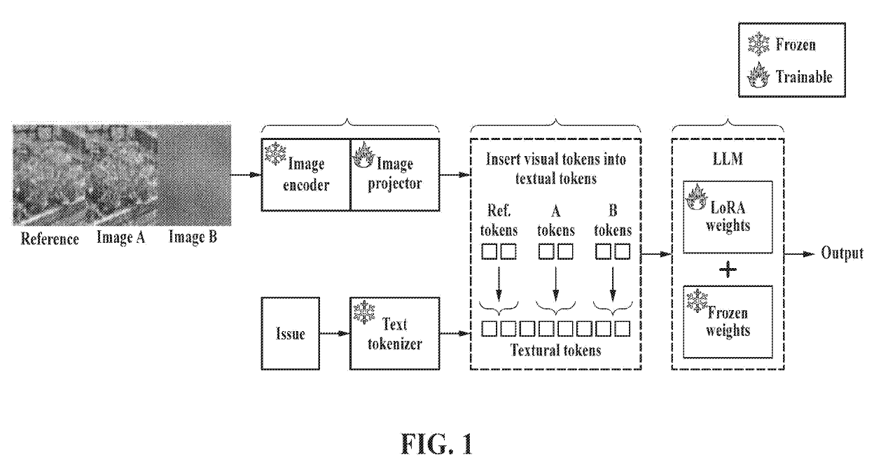

FIG. 1 illustrates an example of a typical DepictQA framework. Referring to FIG. 1, the LLaVA model typically used in DepictQA generally adopts an image encoder of contrastive language-image pre-training (CLIP) as an image feature extractor. Additionally, a multilayer perceptron (MLP)-based projector may be serially connected after an image encoder. During the model fine-tuning process, the parameters of the image encoder may be frozen so that the image encoder does not participate in an update, and the projector and subsequent LLM may participate in fine-tuning.

For example, an input to the DepictQA framework may be image A, image B, where images A and B are both of plants, and the input may also include a question about these two images: "Compare the overall quality of image A and image B and provide a comprehensive description." An output of the DepictQA framework may be "Image A is worse than image B in terms of noise but is much better than image B in terms of blur. Both images perform similarly in terms of brightness distortion, color distortion, and artifacts. In terms of texture quality, the plant texture in image A appears clear, while the plant texture in image B is completely damaged and unidentifiable. This is mainly because the blur of image A works favorably in preserving texture. Therefore, the quality of image A is clearly superior to that of image B."

However, as mentioned above, for images with similar content (also referred to as fine-grained images), the feature similarity extracted by the image encoder of CLIP may be high, which may make it difficult for a subsequent LLM to accurately distinguish the quality differences between images with similar content. In other words, it is difficult to accurately compare and evaluate the quality of fine-grained images in typical frameworks.

In order to solve the above issues existing in these typical frameworks, example IQA methods, devices, electronic devices, storage mediums and computer program products described below may introduce a quality enhancement processing element (or quality enhancer) based on an existing IQA model, thereby extracting lower-level quality features and integrating the quality features as assessment consideration factors of an IQA model together with the existing features of the model. This allows for sufficient consideration of image quality features during image quality comparison and enables more accurate distinction of image quality even for images with similar content, thereby improving performance in fine-grained image quality comparison tasks.

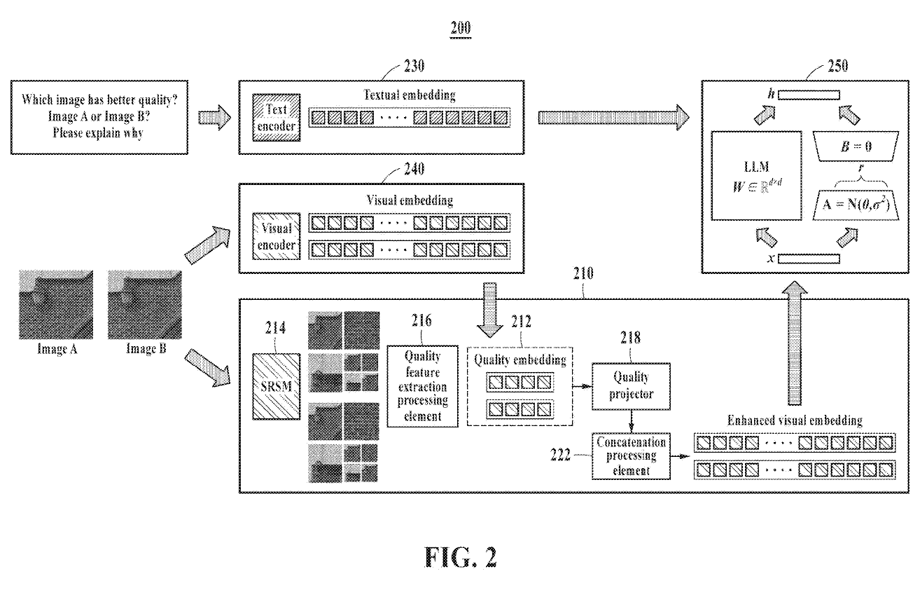

FIG. 2 illustrates an example multimodal large language model (MLLM)-based image quality assessment (IQA) framework according to one or more embodiments.

Referring to FIG. 2, in a non-limiting example, a multimodal large language model (MLLM)-based image quality assessment (IQA) framework 200 may include a text encoder (e.g., including a tokenizer) 230, a visual encoder 240, and an LLM 250. Among the text encoder 230, the visual encoder 240, and the LLM 250, the text encoder 230 may be mainly used to convert character-type content into a vector, and the vector may include a plurality of numeric elements. The visual encoder 240 may be mainly used to extract a semantic feature of an image. The semantic feature may also be referred to as a content feature or a visual feature. The LLM 250 may be used to compare and assess image quality based on an output result of a previous element (i.e., processing element and/or circuitry). However, as mentioned above, although the visual encoder 240 may obtain a semantic feature of an image well, the visual encoder 240 may not be able to obtain a low-level image quality feature well, so typical MLLM-based IQA frameworks may not accurately compare and assess the quality of a fine-grained image.

That is, typical frameworks may include a text encoder, visual encoder, and LLM similar to the text encoder 230, visual encoder 240, and LLM 250 illustrated in FIG. 2. On the other hand, the address the issues existing in the aforementioned typical framework, the multimodal large language model (MLLM)-based image quality assessment (IQA) framework 200 may also include a quality enhancement processing element 210 (i.e., a quality enhancer). The quality enhancement processing element 210 may extract a quality embedding 212 corresponding to at least one quality indicator of an image. The quality embedding 212 may be a vector including a plurality of numeric elements. The quality embedding 212 may be used to represent at least one quality feature of an image. In this way, through the quality enhancement processing element 210, a lower-level quality feature may be extracted, and through this, a quality feature may be integrated as an assessment consideration factor of an IQA model together with the existing features of the model. The quality enhancement processing element 210 may also allow for sufficient consideration of image quality features during image quality comparison and allows for more accurate distinction of the superiority or inferiority of image quality, even for images with similar content.

In an example, the quality enhancement processing element 210 may include a feature extraction processing element 216 (i.e., a feature extractor) configured to extract the quality embedding 212. For example, the quality feature extraction processing element 214 may include a ResNet50 which may be adopted as the encoder for quality feature extraction, and a contrastive learning framework such as SimCLR may be used to enable the encoder to learn rich image quality features through self-supervised pre-training. Additionally, a linear layer may be added after the quality feature extraction processing element 216 and supervised regression for MOS may be performed on an IQA dataset.

In an example, the quality enhancement processing element 210 may further include a salient regions sampling processing element (or sampler) (SRSM) 214. The SRSM 214 may use an image signature as a saliency detector, but examples are not limited thereto. Particularly, first, saliency detection may be performed on an image to be sampled using the image signature to obtain an approximate foreground position of the image, which may be regarded as a fixation point of human gaze movement. Then, a threshold filtering scheme may be used to select a bright region in the image and crop the bright region.

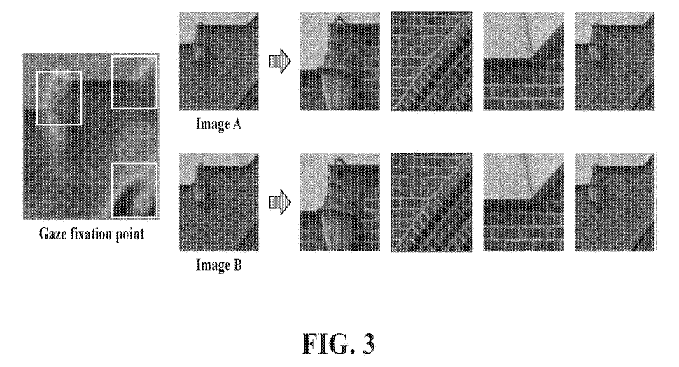

FIG. 3 illustrates an example sampled salient region according to one or more embodiments.

Referring to FIG. 3, in a non-limiting example, three small regions that are outlined with solid lines are illustrated in the leftmost image where these regions may be detected salient regions. In addition to outputting a detected salient region, an SRSM (e.g., SRSM 214) may also output the entire image of the SRSM that is initially input. As shown in FIG. 3, the upper right corner of FIG. 3 sequentially shows the three detected salient regions and the entire image A that is initially input to the SRSM, and the lower right corner of FIG. 3 sequentially shows the three detected salient regions and the entire image B that is initially input to the SRSM.

In an example, the SRSM may sample the salient regions from the images and then transmit the sampled salient regions as an input to a quality feature extractor (e.g., quality feature extraction processing element 216), that is, an encoder, and the final layer output of the encoder may be used as a quality feature. By setting the SRSM, a region that a person is most likely to focus on when comparing image quality may be precisely sampled, and unnecessary sampling of irrelevant regions may be reduced, thereby increasing sampling efficiency.

Referring back to FIG. 2, in an example, the quality enhancement processing element 210 may further include a quality projector 218. The quality projector 218 may be used to obtain an aligned quality embedding by aligning the quality embedding 212 output by the quality feature extraction processing element 216 with a textual embedding output by a text encoder (e.g., text encoder 230). By aligning a target quality embedding with a textual embedding, it may be possible to regularize the relationship between different types of embeddings, thereby enhancing concatenation efficiency.

In an example, the quality enhancement processing element 210 may further include a concatenation processing element 222 (i.e., a concatenator). The concatenation processing element 222may concatenate a textual embedding output by the text encoder 230, a visual embedding output by the visual encoder 240, and a quality embedding output by the quality feature extraction processing element 216, so that a subsequent LLM (e.g., LLM 250) may perform a comparative assessment of image quality based on a concatenated embedding.

However, examples of the embedding concatenation scheme may not be limited to concatenating various embeddings by disposing a concatenation processing element (e.g., concatenation processing element 222) in a quality enhancement processing element (e.g., quality enhancement processing element 210). The concatenation processing element may be disposed as an independent element (i.e., processing element and/or circuitry) outside the quality enhancement processing element to concatenate respective embeddings. For example, it may be possible to concatenate and integrate various embeddings by utilizing a concatenation element (i.e., processing element and/or circuitry) included in the existing MLLM-based IQA framework.

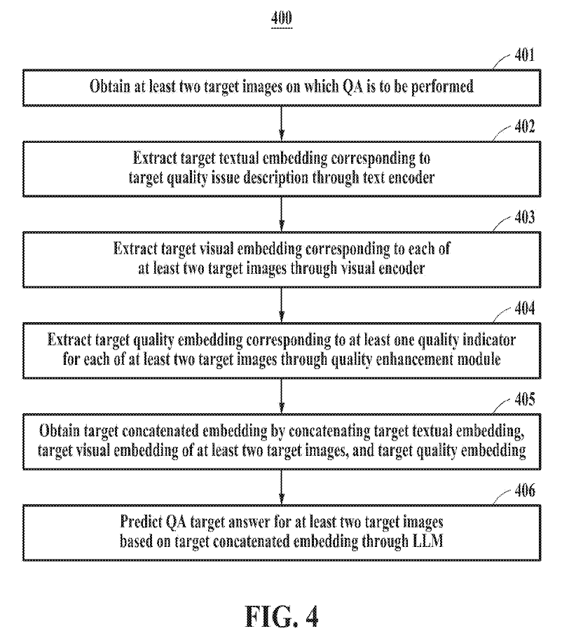

FIG. 4 illustrates an example method with IQA according to one or more embodiments. A method with IQA may be implemented based on an IQA model, and the IQA model may include a text encoder, a visual encoder, an LLM, and a quality enhancer.

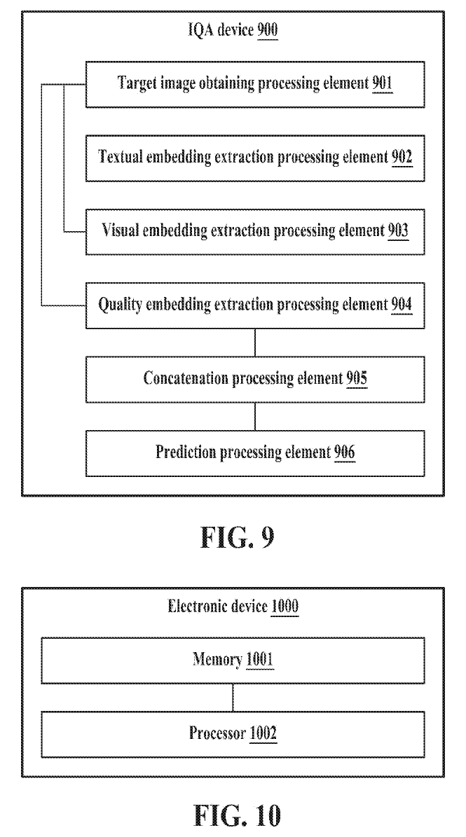

Referring to FIG. 4, in a non-limiting example, method 400 may include operation, where, in operation 401, an electronic device (e.g., an IQA device 900 of FIG. 9) may obtain at least two target images on which QA is to be performed. The at least two target images may correspond to a target quality issue description for the at least two target images. For example, the electronic device may receive a target quality issue description for the at least two target images manually from a user.

For example, as illustrated in FIG. 2, the at least two target images may be image A and image B, respectively, and the target quality issue description for these two target images may be "Which image has better quality? Image A or Image B? Please explain why."

In an example, in operation 402, the electronic device may extract a target textual embedding corresponding to the target quality issue description through a text encoder (e.g., text encoder 230). That is, the electronic device may input the target quality issue description into a text encoder included in a trained IQA model to obtain a target textual embedding corresponding to a target quality issue description. The target textual embedding may be a single vector including a plurality of numeric elements.

For example, as illustrated in FIG. 2, the electronic device may input the target quality issue description "Which image has better quality? Image A or Image B? Please explain why" into the text encoder to obtain a target textual embedding corresponding to the target quality issue description.

In an example, in operation 403, the electronic device may extract a target visual embedding corresponding to each of the at least two target images through a visual encoder (e.g., visual encoder 240). That is, the electronic device may input each of the at least two target images into the visual encoder included in the IQA model to obtain a target visual embedding for the at least two target images. The target visual embedding may be a single vector including a plurality of numeric elements. For example, as illustrated in FIG. 2, the electronic device may input image A and image B into the visual encoder to obtain a target visual embedding for image A and a target visual embedding for image B.

In an example, in operation 404, the electronic device may extract a target quality embedding corresponding to at least one quality indicator for each of the at least two target images through a quality enhancer (e.g., quality enhancement processing element 210). That is, the electronic device may input the at least two target images into a quality enhancer included in the IQA model to obtain a target quality embedding corresponding to at least one quality indicator of the at least two target images. The target quality embedding may be a single vector including a plurality of numeric elements. The target quality embedding may be used to represent at least one quality feature of an image.

For example, as illustrated in FIG. 2, the electronic device may input image A and image B into the quality enhancer to obtain a target quality embedding of image A and a target quality embedding of image B.

The at least one quality indicator may include at least one of chromaticity, contrast, saturation, brightness, noise, Gaussian blur, and compression.

The quality enhancer may include a quality feature extractor (e.g., quality feature extraction processing element 216). The electronic device may extract a quality feature value corresponding to at least one quality indicator for each of the at least two target images through the quality feature extractor. The electronic device may generate a target quality embedding based on a quality feature value corresponding to the at least one extracted quality indicator.

Based on human visual and eye movement mechanisms, a region of interest (ROI) that a person focuses on when observing an image may vary depending on the characteristics of a prompt or question given in advance. Hereinafter, the present disclosure further describes example salient region sampling methods.

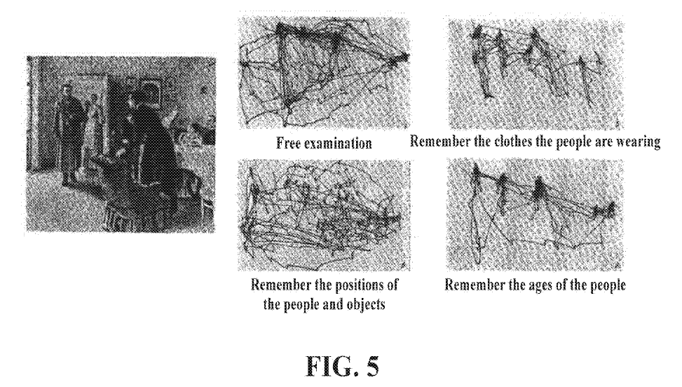

FIG. 5 illustrates example eye movements. In an example, these example eye movements may be derived by or explained from an experiment conducted by Alfred L. Yarbus.

Referring to FIG. 5, in a non-limiting example, example results of the Alfred L. Yarbus experiments are illustrated. For example, in the first small image a "free examination" may indicate that human gaze moves randomly during image observation in the absence of any predefined attention instructions. In contrast, the remaining three small images may indicate that when instructions are given in advance to carefully observe the content, human gaze follows those instructions. For example, the second small image represents the case in which the instruction "remember the clothes the people are wearing" is given. In this case, viewers may focus on the clothing of the people when looking at the corresponding large image on the left. The third small image represents the case in which the instruction "remember the positions of the people and objects" is given. In this case, viewers may focus on the positions of the people and objects within the image. The fourth small image represents the case in which the instruction "remember the ages of the people" is given. In this case, viewers may focus on the ages of the people in the corresponding large image.

In an example, the quality enhancement module may further include an SRSM (e.g., SRSM 214). Through the SRSM, an electronic device (e.g., IQA device 900) may sample at least one salient region from each of at least two target images. For example, as illustrated in FIG. 2, the electronic device may input image A and image B into the SRSM to obtain a salient region sampled from image A and a salient region sampled from image B. Then, the electronic device may extract a quality feature value corresponding to at least one quality indicator from at least one salient region through the quality feature extractor.

Next, the electronic device may generate a target quality embedding based on the quality feature value corresponding to the at least one quality indicator extracted from at least one salient region. For example, as illustrated in FIG. 2, the electronic device may input the salient region sampled from image A and the salient region sampled from image B into the quality feature extractor to obtain a target quality embedding for image A and a target quality embedding for image B.

By setting the SRSM, a region that a person is most likely to focus on when comparing image quality may be precisely sampled, and unnecessary sampling of irrelevant regions may be reduced, thereby increasing sampling efficiency.

Referring back to FIG. 4, in operation 405, the electronic device may obtain a target concatenated embedding by concatenating the target textual embedding, the target visual embedding of at least two target images, and the target quality embedding.

The electronic device may integrate a quality feature extracted from the quality feature extractor, a textual feature extracted from the text encoder, and a visual feature extracted from a CLIP image encoder within the existing DepictQA framework through two quality feature integration schemes. These two quality feature integration schemes may include pure concatenation and quality projector-based integration schemes. The details are as follows.

### 1. Pure concatenation

Since a transformer structure of an LLM is not sensitive to the token length dimension of an input token embedding, the three features mentioned above may be directly concatenated and fused through a tensor concatenation scheme.

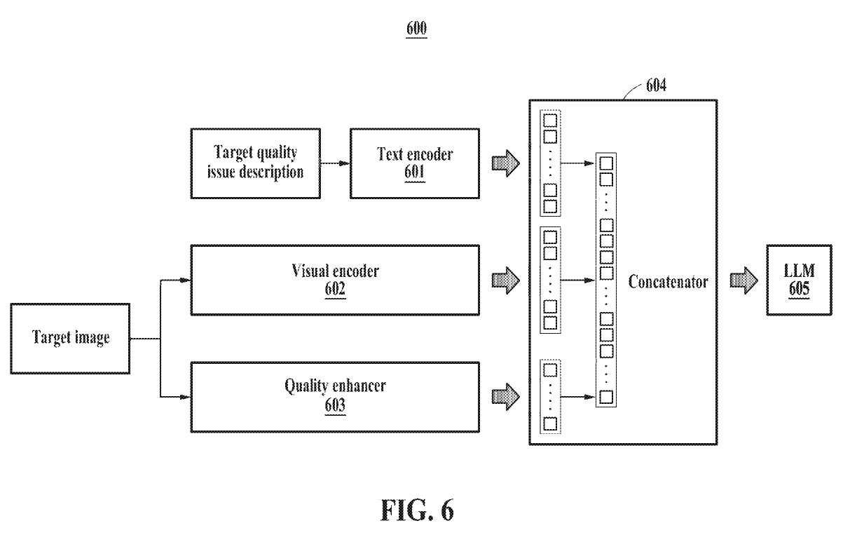

FIG. 6 illustrates an example process with pure concatenation according to one or more embodiments.

Referring to FIG. 6, in a non-limiting example, a process 600 may be performed with an electronic device (e.g., IQA device 900) configured to generate a target textual embedding by inputting a target quality issue description into a text encoder 601. Additionally, the electronic device may generate a target visual embedding by inputting a target image into a visual encoder 602 of CLIP. For example, the visual encoder 602 of CLIP may be ViT, ResNet, and the like, but examples are not limited thereto. The electronic device may generate a target quality embedding by inputting the target image into a quality enhancer 603. Next, using a concatenator 604, the electronic device may obtain a target concatenated embedding by directly concatenating the target textual embedding, the target visual embedding, and the target quality embedding. Finally, the electronic device may obtain a response output by inputting, into a subsequent LLM 605, a feature obtained by integrating the quality features. In addition, although FIG. 6 illustrates that the concatenator 604 is disposed outside the quality enhancer 603, this is only an example. For example, the concatenator 604 may be one element (i.e., processing element and/or circuitry) within the quality enhancer 603.

In this way, examples of the electronic device may sufficiently consider features from various aspects of an image by integrating quality features with features of an existing MLLM, thereby improving the performance of a model in a fine-grained image quality comparison task.

### 2. Quality projector-based integration

A feature extracted by a MOS regression-based IQA model may have the ability to determine image quality, but the feature may not be aligned with natural language. Therefore, as illustrated in FIG. 2, the electronic device may utilize a quality projector-based feature integration scheme. The electronic device may use a quality projector (e.g., quality projector 218) to align the target quality embedding output by the quality feature extraction module. Accordingly, the aligned target quality embedding may be aligned with the target textual embedding output by the text encoder.

Particularly, the electronic device may input the target quality embedding extracted by the quality feature extractor (e.g., quality feature extraction processing element 216) into an MLP-based quality projector to perform alignment processing. Additionally, the quality projector may participate in the learning process of the entire model. That is, during the training process of the IQA model, the electronic device may adjust not only a parameter of the LLM but also a parameter of the quality projector. The aforementioned "alignment processing" may refer to projecting two vectors into a high-dimensional space and minimizing the distance between the vectors as much as possible. Then, an output result of the quality projector, a visual feature extracted by the CLIP image encoder, and a target textual embedding extracted by the text encoder may be concatenated in the token length dimension.

The quality enhancer may also include a quality projector. The electronic device may obtain an aligned target quality embedding by aligning a target quality embedding of at least two target images with the target textual embedding through the quality projector. Then, the electronic device may obtain a target concatenated embedding by concatenating the target textual embedding, the target visual embedding of at least two target images, and the aligned target quality embedding.

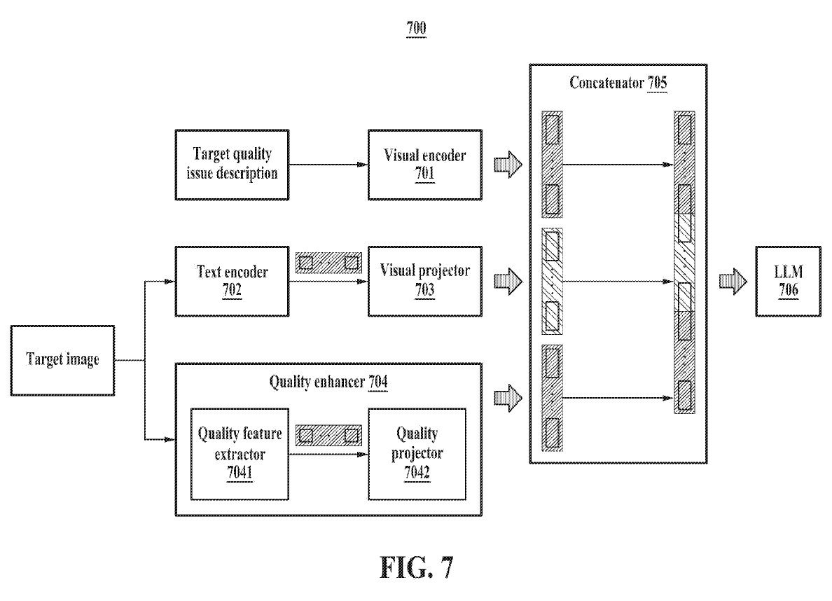

FIG. 7 illustrates an example process with feature integration based on a quality projector and a visual projector according to one or more embodiments.

Referring to FIG. 7, in a non-limiting example, process 700 may include an electronic device (e.g., an IQA device) configured to obtain a target textual embedding by inputting a target quality issue description into a text encoder 701. The electronic device may obtain a target visual embedding by inputting a target image into a visual encoder 702 of CLIP. Additionally, the electronic device may input the target visual embedding into a visual projector 703 and perform alignment processing on the target visual embedding so that the aligned target visual embedding is aligned with the target textual embedding. The electronic device may obtain a target quality embedding by inputting a target image into a quality feature extractor 7041 included in a quality enhancement module 704. Additionally, the electronic device may input the target quality embedding into a quality projector 7042 included in the quality enhancer 704 and perform alignment processing, so that the aligned target quality embedding is aligned with the target textual embedding.

Next, using the concatenator 705, the electronic device may obtain a target concatenated embedding by concatenating the target textual embedding, the aligned target visual embedding, and the aligned target quality embedding. Finally, the electronic device may obtain a response output by inputting, into a subsequent LLM 706, a feature obtained by integrating the quality features. In addition, although FIG. 7 illustrates that the concatenator 705 is disposed outside the quality enhancer 704, this is only an example. For example, the concatenator 705 may be an element (i.e., processing element and/or circuitry) within the quality enhancer 704. By aligning the target quality embedding with the target textual embedding, the electronic device may regularize the relationship between different types of embeddings, thereby enhancing concatenation efficiency.

Referring back to FIG. 4, in an example, in operation 406, based on the target concatenated embedding, the electronic device may predict a QA target answer for the at least two target images through the LLM. For example, as illustrated in FIG. 2, the electronic device may obtain a QA target answer for image A and image B by inputting the target concatenated embedding into the LLM. For example, the QA target answer may be "Image A has higher quality than image B."

For example, the QA target answer may include a quality comparison result of the at least two target images and a causal inference description for the quality comparison result. In this way, the electronic device may enable an IQA model to not only predict the quality superiority or inferiority between images, but also infer the cause of the difference in image quality, through a QA answer that includes a quality comparison result and a causal inference description of the quality comparison result. That is, this approach enriches the functionality of an IQA model, allowing for the delivery of a more comprehensive service to a user.

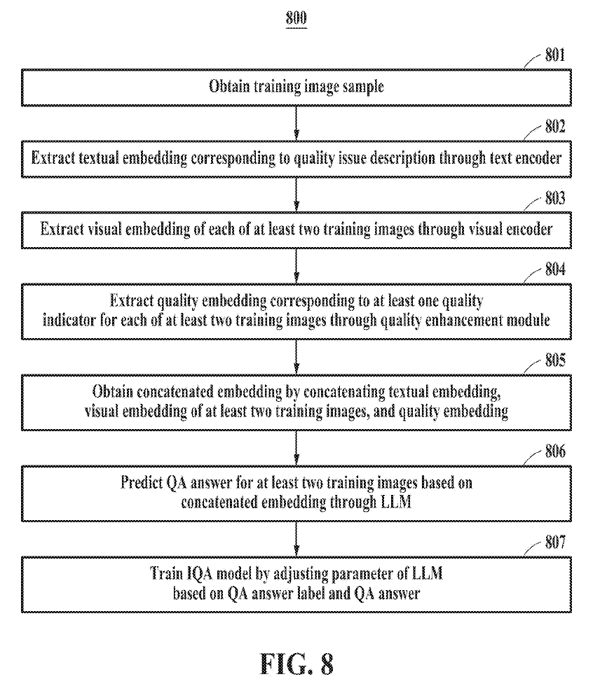

FIG. 8 illustrates an example method with IQA model training according to one or more embodiments.

Referring to FIG. 8, in a non-limiting example, method 800 may include an electronic device (e.g., IQA device 900) obtaining a training image sample in operation 801. The training image sample may include at least two training images, a quality issue description for the at least two training images, and a corresponding QA answer label. For example, as illustrated in FIG. 2, the training image sample may include two training images, which may be image A and image B. The target quality issue description for these two training images may be :"Which image has better quality? Image A or Image B? Please explain why." The QA answer label for these two training images may be "Image A has higher quality than image B."

In an example, in operation 802, the electronic device may extract a textual embedding corresponding to the quality issue description through a text encoder (e.g., text encoder 230). The text encoder in the training context may also be referred to as a training text encoder. That is, the electronic device may obtain a textual embedding corresponding to the quality issue description by inputting the quality issue description into the text encoder. The textual embedding may be a single vector including a plurality of numerical elements. For example, as illustrated in FIG. 2, the electronic device may input the quality issue description "Which image has better quality? Image A or Image B? Please explain why" into the text encoder to obtain a textual embedding corresponding to the quality issue description.

In an example, in operation 803, the electronic device may extract a visual embedding of each of the at least two training images through a visual encoder (e.g., visual encoder 240). The visual encoder in the training context may also be referred to as a training visual encoder. That is, the electronic device may obtain a visual embedding for the at least two training images by inputting the at least two training images into the visual encoder. The visual embedding may be a single vector including a plurality of numerical elements. For example, as illustrated in FIG. 2, the electronic device may input image A and image B into the visual encoder to obtain a visual embedding for image A and a visual embedding for image B.

In an example, in operation 804, the electronic device may extract a quality embedding corresponding to at least one quality indicator for each of the at least two training images through a quality enhancer (e.g., quality enhancement processing element 210). The quality enhancer in the training context may also be referred to as, for example, a training quality enhancer. That is, the electronic device may obtain a quality embedding corresponding to at least one quality indicator of the at least two training images by inputting the at least two training images into the quality. The quality embedding may be a single vector including a plurality of numerical elements. The quality embedding may be used to represent at least one quality feature of an image. For example, as illustrated in FIG. 2, the electronic device may input image A and image B into the quality enhancer to obtain a quality embedding of image A and a quality embedding of image B.

For example, the at least one quality indicator may include at least one of chromaticity, contrast, saturation, brightness, noise, Gaussian blur, and compression.

The quality enhancer may further include a quality feature extractor (e.g., quality feature extraction processing module 216). The electronic device may extract a quality feature value corresponding to the at least one quality indicator for each of the at least two training images through the quality feature extractor and may generate a quality embedding based on the quality feature value corresponding to the at least one extracted quality indicator.

The quality enhancer may further include an SRSM (e.g., SRSM 214). The SRSM in the training context may also be referred to as a training salient regions sampler and/or a training salient regions processing element. The electronic device may sample at least one salient region from each of the at least two training images through the SRSM. Then, the electronic device may extract a quality feature value corresponding to at least one quality indicator from at least one salient region through the quality feature extractor. Next, the electronic device may generate a quality embedding based on a quality feature value corresponding to the at least one quality indicator extracted from the at least one salient region.

By setting the SRSM, the electronic device may precisely sample a region that a person is most likely to focus on when comparing image quality and reduce unnecessary sampling of irrelevant regions, thereby increasing sampling efficiency.

In an example, in operation 805, the electronic device may obtain a concatenated embedding by concatenating the textual embedding (i.e., through the concatenation processing element 222), the visual embedding of the at least two training images, and the quality embedding.

The quality enhancer may further include a quality projector (e.g., quality projector 218). The electronic device may obtain an aligned quality embedding by aligning the quality embedding of the at least two training images with the textual embedding through the quality projector. Then, the electronic device may obtain a concatenated embedding by concatenating the textual embedding, the visual embedding of the at least two training images, and the aligned quality embedding. Finally, the electronic device may obtain a response output by inputting, into a subsequent LLM (e.g., LLM 250), a feature obtained by integrating the quality features. By aligning the target quality embedding with the textual embedding, the electronic device may regularize the relationship between different types of embeddings, thereby enhancing concatenation efficiency.

In an example, in operation 806, the electronic device may predict a QA answer for the at least two training images based on the concatenated embedding through an LLM. For example, as illustrated in FIG. 2, the electronic device may obtain a QA answer for images A and B by inputting the concatenated embedding into the LLM. For example, the QA answer may be "Image A has higher quality than image B."

In an example, in operation 807, it may be possible to train an IQA model by adjusting a parameter of the LLM based on a QA answer label and the QA answer.

For example, the QA answer may include a quality comparison result of the at least two training images and a causal inference description for the quality comparison result. In this way, the electronic device may enable an IQA model to not only predict the quality superiority or inferiority between images, but also infer the cause of the difference in image quality, by utilizing a QA answer that includes the quality comparison result and the causal inference description of the quality comparison result. That is, this approach enriches the functionality of an IQA model, allowing for the delivery of a more comprehensive service to a user. In addition, any one or all of these actions and/or values may be referred to as training actions and/or values (e.g., a training textual embedding).

FIG. 9 illustrates an example electronic apparatus with IQA according to one or more embodiments. An electronic apparatus (e.g., an IQA device 900) may be implemented based on an IQA model, and the IQA model may include a text encoder (e.g., text encoder 230), a visual encoder (e.g., visual encoder 240), and an LLM (e.g., LLM 250).

Referring to FIG. 9, in a non-limiting example, the IQA device 900 may include a target image obtaining processing element 901, a textual embedding extraction processing element 902, a visual embedding extraction processing element 903, a quality embedding extraction processing element 904, a concatenation processing element 905, and a prediction processing element 906.

In an example, the target image obtaining processing element 901 may obtain at least two target images on which QA is to be performed. The at least two target images may correspond to a target quality issue description for the at least two target images. For example, the IQA device 900 may manually receive, from a user, a target quality issue description for the at least two target images.

In an example, the textual embedding extraction processing element 902 may extract a target textual embedding corresponding to a target quality issue description through a text encoder. That is, the textual embedding extraction processing element 902 may obtain the target textual embedding corresponding to the target quality issue description by inputting the target quality issue description into the text encoder included in a trained IQA model. The target textual embedding may be a single vector including a plurality of numeric elements.

In an example, the visual embedding extraction processing element 903 may extract a target visual embedding of each of the at least two target images through the visual encoder. That is, the visual embedding extraction processing element 903 may obtain a target visual embedding for the at least two target images by inputting the at least two target images into the visual encoder included in the IQA model. The target visual embedding may be a single vector including a plurality of numeric elements.

In an example, the quality embedding extraction processing element 904 may extract a target quality embedding corresponding to at least one quality indicator for each of the at least two target images through a quality enhancement processing element. That is, the quality embedding extraction processing element 904 may obtain the target quality embedding corresponding to the at least one quality indicator of the at least two target images by inputting the at least two target images into the quality enhancement processing element included in the IQA model. The target quality embedding may be a single vector including a plurality of numeric elements, and the target quality embedding may be used to represent at least one quality feature of an image.

The at least one quality indicator may include at least one of chromaticity, contrast, saturation, brightness, noise, Gaussian blur, and compression.

In an example, the quality enhancement processing element may include a quality feature extraction processing element. The quality embedding extraction processing element 904 may extract a quality feature value corresponding to at least one quality indicator for each of the at least two target images through the quality feature extraction processing element and may generate a target quality embedding based on a quality feature value corresponding to at least one extracted quality indicator.

The quality enhancement processing element may further include an SRSM. The quality embedding extraction processing element 904 may sample at least one salient region from each of the at least two target images through the SRSM Then, the quality embedding extraction processing element 904 may extract a quality feature value corresponding to at least one quality indicator from at least one salient region through the quality feature extraction processing element. Next, the quality embedding extraction processing element 904 may generate a target quality embedding based on the quality feature value corresponding to the at least one quality indicator extracted from the at least one salient region.

By setting the SRSM, a region that a person is most likely to focus on when comparing image quality may be precisely sampled, and unnecessary sampling of irrelevant regions may be reduced, thereby increasing sampling efficiency.

In an example, the concatenation processing element 905 may obtain a concatenated embedding by concatenating the textual embedding, the visual embedding of the at least two training images, and the quality embedding.

In an example, the quality enhancement processing element may further include a quality projector. The concatenation processing element 905 may obtain an aligned target quality embedding by aligning a quality embedding of at least two target images with the target textual embedding through the quality projector. Then, the concatenation processing element 905 may obtain a target concatenated embedding by concatenating the target textual embedding, the target visual embedding of at least two target images, and the aligned target quality embedding.

By aligning the target quality embedding with the target textual embedding, it may be possible to regularize the relationship between different types of embeddings, thereby enhancing concatenation efficiency.

In an example, the prediction processing element 906 may predict a QA target answer for the at least two target images based on a target concatenated embedding through the LLM.

The QA target answer may include a quality comparison result of the at least two target images and a causal inference description for the quality comparison result. In this way, by including the quality comparison result and the causal inference description of the quality comparison result in the QA answer, the IQA model may not only predict the quality superiority or inferiority between images, but also infer the cause of the difference in image quality. That is, this approach enriches the functionality of an IQA model, allowing for the delivery of a more comprehensive service to a user.

In an example, the electronic apparatus may train the IQA model using the training method described below.

First, the electronic apparatus may obtain a training image sample. The training image sample may include at least two training images, a quality issue description for the at least two training images, and a corresponding QA answer label.

The electronic apparatus may then extract a textual embedding corresponding to a quality issue description through a text encoder. That is, the electronic apparatus may obtain a textual embedding corresponding to the quality issue description by inputting the quality issue description into the text encoder. The textual embedding may be a single vector including a plurality of numerical elements.

Next, the electronic apparatus may extract a visual embedding for each of at least two training images through a visual encoder. That is, the electronic apparatus may obtain a visual embedding for the at least two training images by inputting the at least two training images into the visual encoder. The visual embedding may be a single vector including a plurality of numerical elements.

Then, the electronic apparatus may extract a quality embedding corresponding to at least one quality indicator for each of the at least two training images through a quality enhancement processing element. That is, the electronic apparatus may obtain a quality embedding corresponding to at least one quality indicator of the at least two training images by inputting the at least two training images into the quality enhancement processing element. The quality embedding may be a single vector including a plurality of numerical elements. The quality embedding may be used to represent at least one quality feature of an image.

Next, the electronic apparatus may obtain a concatenated embedding by concatenating the textual embedding, the visual embedding of the at least two training images, and the quality embedding.

Subsequently, the electronic apparatus may predict a QA answer for the at least two training images based on the concatenated embedding through an LLM.

Next, the electronic apparatus may train an IQA model by adjusting a parameter of the LLM based on a QA answer label and a QA answer.

The quality enhancement processing element may further include a quality feature extraction processing element. The electronic apparatus may extract a quality feature value corresponding to the at least one quality indicator for each of the at least two training images through the quality feature extraction processing element and may generate a quality embedding based on the quality feature value corresponding to the at least one extracted quality indicator.

In an example, the quality enhancement processing element may further include an SRSM. The electronic apparatus may sample at least one salient region from each of the at least two training images through the SRSM. Then, the electronic apparatus may extract a quality feature value corresponding to at least one quality indicator from at least one salient region through the quality feature extraction processing element. Next, the electronic apparatus may generate a quality embedding based on a quality feature value corresponding to the at least one quality indicator extracted from the at least one salient region.

By setting the SRSM, a region that a person is most likely to focus on when comparing image quality may be precisely sampled, and unnecessary sampling of irrelevant regions may be reduced, thereby increasing sampling efficiency.

In an example, the quality enhancement processing element may further include a quality projector. The electronic apparatus may obtain an aligned quality embedding by aligning the quality embedding of the at least two training images with the textual embedding through the quality projector. Then, the electronic apparatus may obtain a concatenated embedding by concatenating the textual embedding, the visual embedding of the at least two training images, and the aligned quality embedding. Finally, the electronic apparatus may obtain a response output by inputting, into a subsequent LLM, a feature obtained by integrating the quality features. By aligning the quality embedding with the textual embedding, it may be possible to regularize the relationship between different types of embeddings, thereby enhancing concatenation efficiency.

The QA answer may include a quality comparison result of the at least two training images and a causal inference description for the quality comparison result. In this way, by including the quality comparison result and the causal inference description of the quality comparison result in the QA answer, the IQA model may not only predict the quality superiority or inferiority between images, but also infer the cause of the difference in image quality. That is, this approach enriches the functionality of an IQA model, allowing for the delivery of a more comprehensive service to a user.

FIG. 10 illustrates an example electronic device according to one or more embodiments.

Referring to FIG. 10, in a non-limiting example, the electronic device 1000 may include at least one memory 1001 and at least one processor 1002. The at least one memory 1001 may store instructions, and when the instruction is executed by the at least one processor 1002, an IQA method (e.g., method 400) may be executed.

For example, the electronic device 1000 may be a personal computer (PC), a tablet device, a personal digital assistant (PDA), a smartphone, or other devices for executing an instruction set. Here, the electronic device 1000 may not need to be a single electronic device and may be a device or assembly of circuits capable of executing instructions (or an instruction set) individually or collectively. The electronic device 1000 may also be a part of an integrated control system or a system manager or may be configured as a portable electronic device that locally or remotely (e.g., via wireless transmission) interfaces.

The at least one processor 1002 may be configured to execute programs or applications to configure the at least one processor 1002 to control the electronic device 1000 to perform one or more or all operations and/or methods with IQA, and may include any one or a combination of two or more of, for example, a central processing unit (CPU), a graphic processing unit (GPU), a neural processing unit (NPU) and tensor processing units (TPUs), but is not limited to the above-described examples. For example, the at least one processor 1002 may further include an analog processor, a digital processor, a microprocessor, a multicore processor, a processor array, a network processor, and the like.

The at least one processor 1002 may execute the instructions or code stored in the at least one memory 1001. The at least one memory 1001 may store data. The instructions and data may also be transmitted and received over a network via a network interface device. The network interface device may utilize any known transport protocol.

The at least one memory 1001 may be integrated with the at least one processor 1002 by arranging, for example, random-access memory (RAM) or flash memory in an integrated circuit microprocessor, or the like. In addition, the at least one memory 1001 may include an independent device, such as an external disk drive, a storage array, or other storage devices that may be used by any database system. The at least one memory 1001 and the at least one processor 1002 may be operatively connected to each other or may communicate with each other through an input/output (I/O) port or a network connection so that the at least one processor 1002 may read a file stored in the at least one memory 1001.

The at least one memory 1001 may include computer-readable instructions. The at least one processor 1002 may be configured to execute computer-readable instructions, such as those stored in the at least one memory 1001, and through execution of the computer-readable instructions, the at least one processor 1002 may be configured to perform one or more, or any combination, of the operations and/or methods described herein.

In addition, the electronic device 1000 may further include a video display (e.g., a liquid crystal display (LCD)) and a user interaction interface (e.g., a keyboard, a mouse, a touch input device, etc.). All components of the electronic device 1000 may be connected to one another through a bus and/or a network.

Instructions stored in a non-transitory computer-readable storage medium, when executed by a processor of an electronic device, may cause the electronic device to execute the IQA method described above. .

A computer program product may include a computer program. The computer program may be executed by a processor to implement the IQA method described above.

According to the IQA method, device, electronic device, storage medium, and computer program product described above, a quality enhancement processing element may be additionally introduced based on an existing IQA model, thereby extracting lower-level quality features and integrating the quality features together with the existing features of the model as assessment consideration factors of an IQA model. This allows for sufficient consideration of image quality features during image quality comparison and enables more accurate distinction of image quality even for images with similar content, thereby improving performance in fine-grained image quality comparison tasks.

By setting an SRSM, a region that a person is most likely to focus on when comparing image quality may be precisely sampled, and unnecessary sampling of irrelevant regions may be reduced, thereby increasing sampling efficiency.

The electronic device may sufficiently consider features from various aspects of an image by integrating quality features with features of an existing MLLM, thereby improving the performance of a model in a fine-grained image quality comparison task.

By aligning a quality embedding with a textual embedding, it may be possible to regularize the relationship between different types of embeddings, thereby enhancing concatenation efficiency.

By including a quality comparison result and a causal inference description of the quality comparison result in a QA answer, an IQA model may not only predict the quality superiority or inferiority between images, but also infer the cause of the difference in image quality, thus enhancing the functionality of the IQA model and offering a more comprehensive service to a user.

The electronic apparatuses, processors, memories, neural networks, text encoder 230, visual encoder 240, large language model 250, quality enhancement processing element 210, quality feature extraction processing element 216, salient regions sampling processing element 214, quality projector 218, concatenation processing element 222, text encoder 601 , visual encoder 602, quality enhancer 603 , concatenator 604, large language model 605, text encoder 701, visual encoder 702, visual projector 703, quality feature extractor 7041, quality projector 7042, concatenator 705, large language model (LLM) 706, target image obtaining processing element 901, textual embedding extraction processing element 902, visual embedding extraction processing element 903, quality embedding extraction processing element 904, concatenation processing element 905 prediction processing element 906, target image obtaining processing element 901, textual embedding extraction processing element 902, visual embedding extraction processing element 903, quality embedding extraction processing element 904, concatenation processing element 905, prediction processing element 906, electronic device 1000, at least one memory 1001, and at least one processor 1002 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-9 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
extracting a target textual embedding corresponding to a target quality issue description related to at least two target images through a text encoder of an image quality assessment (IQA) model;
extracting a target visual embedding for the at least two target images through a visual encoder of the IQA model;
extracting a target quality embedding corresponding to at least one quality indicator for the at least two target images through a quality enhancer of the IQA model;
obtaining a target concatenated embedding by concatenating the target textual embedding, the target visual embedding of the at least two target images, and the target quality embedding; and
predicting a QA target answer for the at least two target images through a large language model (LLM) of the IQA model based on the target concatenated embedding.

2. The method of claim 1, wherein the quality enhancer comprises a quality projector, and
wherein the obtaining of the target concatenated embedding comprises:
aligning the target quality embedding of the at least two target images with the target textual embedding through the quality projector to obtain an aligned target quality embedding; and
concatenating the target textual embedding, the target visual embedding of the at least two target images, and the aligned target quality embedding to obtain the target concatenated embedding.

3. The method of claim 1, wherein the quality enhancer comprises a quality feature extractor, and
wherein the extracting of the target quality embedding comprises:
extracting a quality feature value corresponding to the at least one quality indicator for each of the at least two target images through the quality feature extractor; and
generating the target quality embedding based on the extracted quality feature value.

4. The method of claim 3, wherein the quality enhancer further comprises a salient regions sampler,
wherein the method further comprises:
sampling at least one salient region from each of the at least two target images through the salient regions sampler, and
wherein the extracting of the quality feature value comprises extracting a quality feature value corresponding to the at least one quality indicator from the at least one salient region through the quality feature extractor.

5. The method of claim 1, wherein the QA target answer includes a quality comparison result of the at least two target images and a causal inference description for the quality comparison result.

6. The method of claim 1, wherein the at least one quality indicator includes any one or any combination of chromaticity, contrast, saturation, brightness, noise, Gaussian blur, and compression.

7. The method of claim 1, further comprising training the IQA model, the training comprising:
obtaining a training image sample including at least two training images, a training quality issue description for the at least two training images, and a corresponding training QA answer label;
extracting a training textual embedding corresponding to the training quality issue description through a training text encoder;
extracting a training visual embedding for each of the at least two training images through a training visual encoder;
extracting a quality embedding corresponding to at least one quality indicator for each of the at least two training images through a training quality enhancer;
obtaining a concatenated embedding by concatenating the training textual embedding, the training visual embedding of the at least two training images, and the training quality embedding;
predicting a training QA answer for the at least two training images through the LLM based on the concatenated embedding; and
training the IQA model by adjusting a parameter of the LLM based on the training QA answer label and the training QA answer.

8. The method of claim 7, wherein the obtaining of the training concatenated embedding comprises:
obtaining a training aligned quality embedding by aligning the training quality embedding of the at least two training images with the training textual embedding through a training quality projector; and
obtaining a training concatenated embedding by concatenating the training textual embedding, the training visual embedding of the at least two training images, and the training aligned quality embedding, and
wherein the adjusting of the parameter of the LLM comprises adjusting parameters of the LLM and the quality projector.

9. The method of claim 7, wherein the extracting of the training quality embedding comprises:
extracting a training quality feature value corresponding to the at least one training quality indicator for each of the at least two training images through a training quality feature extractor; and
generating the training quality embedding based on the extracted training quality feature value.

10. The method of claim 9, wherein the training further comprises:
sampling at least one salient region from each of the at least two training images through a training salient regions sampler, and
wherein the extracting of the training quality feature value comprises:
extracting the training quality feature value corresponding to the at least one training quality indicator from the at least one salient region through the training quality feature extractor.

11. The method of claim 7, wherein the training QA answer includes a training quality comparison result of the at least two training images and a training causal inference description for the training quality comparison result.

12. A non-transitory computer-readable storage medium storing instructions that, when executed by a processor, cause the processor to perform the method of claim 1.

13. An electronic device, comprising:
at least one processor; and
a memory storing instructions,
wherein the instructions, in response to being executed by the at least one processor individually or collectively, cause the electronic device to:
extract a target textual embedding corresponding to a target quality issue description related to at least two target images through a text encoder of an image quality assessment (IQA) model;
extract a target visual embedding for the at least two target images through a visual encoder of the IQA model;
extract a target quality embedding corresponding to at least one quality indicator for the at least two target images through a quality enhancement processing element of the IQA model;
obtain a target concatenated embedding by concatenating the target textual embedding, the target visual embedding of the at least two target images, and the target quality embedding; and
predict a QA target answer for the at least two target images through a large language model (LLM) of the IQA model based on the target concatenated embedding.

14. The electronic device of claim 13, wherein the quality enhancement processing element comprises a quality projector, and
wherein the instructions, in response to being executed by the at least one processor individually or collectively, cause the electronic device to:
align the target quality embedding of the at least two target images with the target textual embedding through the quality projector to obtain an aligned target quality embedding; and
concatenate the target textual embedding, the target visual embedding of the at least two target images, and the aligned target quality embedding to obtain the target concatenated embedding.

15. The electronic device of claim 13, wherein the quality enhancement processing element comprises a quality feature extraction processing element, and
wherein the instructions, in response to being executed by the at least one processor individually or collectively, cause the electronic device to:
extract a quality feature value corresponding to the at least one quality indicator for each of the at least two target images through the quality feature processing element ; and
generate the target quality embedding based on the extracted quality feature value.

16. The electronic device of claim 15, wherein the quality enhancement processing element further comprises a salient regions sampling processing element, and
wherein the instructions, in response to being executed by the at least one processor individually or collectively, cause the electronic device to:
sample at least one salient region from each of the at least two target images through the salient regions sampling processing element; and
extract the quality feature value corresponding to the at least one quality indicator from the at least one salient region through the quality feature extraction processing element.

17. The electronic device of claim 13, wherein the QA target answer includes a quality comparison result of the at least two target images and a causal inference description for the quality comparison result.

18. The electronic device of claim 13, wherein the at least one quality indicator includes any one or any combination of chromaticity, contrast, saturation, brightness, noise, Gaussian blur, and compression.

19. The electronic device of claim 13, wherein the instructions, in response to being executed by the at least one processor individually or collectively, cause the electronic device to:
train the IQA model, the training of the IQA model comprising:
obtaining a training image sample including at least two training images, a training quality issue description for the at least two training images, and a corresponding training QA answer label;
extracting a training textual embedding corresponding to the training quality issue description through a training text encoder;
extracting a training visual embedding for each of the at least two training images through a training visual encoder;
extracting a quality embedding corresponding to at least one quality indicator for each of the at least two training images through a training quality enhancer;
obtaining a concatenated embedding by concatenating the training textual embedding, the training visual embedding of the at least two training images, and the training quality embedding;
predicting a training QA answer for the at least two training images through the LLM based on the concatenated embedding; and
training the IQA model by adjusting a parameter of the LLM based on the training QA answer label and the training QA answer.

20. The electronic device of claim 19, wherein the obtaining of the training concatenated embedding comprises:
obtaining a training aligned quality embedding by aligning the training quality embedding of the at least two training images with the training textual embedding through a training quality projector; and
obtaining a training concatenated embedding by concatenating the training textual embedding, the training visual embedding of the at least two training images, and the training aligned quality embedding, and
wherein the adjusting of the parameter of the LLM comprises adjusting parameters of the LLM and the quality projector.
